(19) United States
(12) Patent Application Publication
(10) Pub. No.: US 2011/0248666 A1
(43) Pub. Date: Oct. 13, 2011

(54) Turbine-powered electric vehicle

(76) Inventor: Leigh Lorenson, Richwood, TX (US)

(21) Appl. No.: 12/930,619

(22) Filed: Jan. 12, 2011

Related U.S. Application Data
(60) Provisional application No. 61/336,278, filed on Jan. 20, 2010.

(51) Int. Cl. H02J 7/00

(52) U.S. Cl. 320/101

(57) ABSTRACT

A turbine powered vehicle is provided. The turbine is mounted on the vehicle so that when the battery-started vehicle moves forward, air impinges on selected vanes within the turbine, causing the turbine to turn. Turning of the turbine runs a linked alternator, which puts energy into the battery in the vehicle.

### CROSS-REFERENCE TO RELATED APPLICATIONS

This application claims priority from U.S. Provisional Application Ser. No. 61/336,278, filed Jan. 20, 2010.

### BACKGROUND OF THE INVENTION

1. Field of the Invention

This invention relates to electrical vehicles, and in particular relates to an electrical vehicle having a turbine electrical generating system.

2. Description of the Related Art

There is a tremendous need to cut consumption of gas and oil in the United States and the rest of the world, as well as a need to eliminate exhaust emission from the burning of fossil fuels. There have been many attempts to create vehicles with reduced requirements for gasoline, including various types of hybrid and battery-powered cars.

While it is known to turn a wheel by having a fluid impinge upon vanes in a turbine, for example, in a water wheel, it is not known to harness movement of an air-driven turbine to power a vehicle according to the invention herein.

It is therefore an object of the invention to provide a battery-started vehicle that when it is moving utilizes wind power harnessed by means of a turbine to generate energy and to continue movement of the vehicle. It is a further object of the invention to provide a vehicle that is started and first moved forward by a battery installation, but then is able to move forward using energy obtained from an alternator harnessed to turbine fins that rotate due to being pushed by air entering the turbine, without requiring an engine, a radiator, a gas tank or an exhaust system, and therefore used neither gasoline or other liquid fuel nor produces gaseous emissions.

Other objects and advantages will be more fully apparent from the following disclosure and appended claims.

### SUMMARY OF THE INVENTION

The invention herein is a turbine powered vehicle. The turbine is mounted on the vehicle so that when the battery-started vehicle moves forward, air impinges on selected vanes within the turbine, causing the turbine to turn. Turning of the turbine runs a linked alternator, which puts energy into the battery in the vehicle.

Other objects and features of the inventions will be more fully apparent from the following disclosure and appended claims.

### BRIEF DESCRIPTION OF THE DRAWINGS

FIG. 1 is a side perspective view of a truck having a turbine in a shroud according to the invention mounted on the cab of the truck.

FIG. 2A is a side perspective view of a turbine according the invention herein.

FIG. 2B is a side perspective view of the turbine of FIG. 2A after the flat steel plate is placed over the hub.

FIG. 2C is a side perspective view of an alternative embodiment of the turbine having rounded fins.

FIG. 3A is a partial front view of the truck of FIG. 1 with the invention mounted thereon.

FIG. 3B is a partial front perspective view of a shroud for a turbine of the invention.

FIG. 3C is a front top perspective view of the shroud and turbine on the top of a vehicle.

FIG. 3D is a partial side perspective view of the shroud and turbine on the top of a vehicle.

FIG. 4 is a side perspective view of a mounting structure that may be used to hold the turbine of the invention on a vehicle.

FIG. 5 is side perspective view of the turbine mounted in a turbine support bracket.

FIG. 6 is partial cross-sectional view showing mounting of the alternator and turbine.

FIG. 7 is a perspective view of the underside of the turbine.

FIG. 8 is a perspective view of the belt connection of the turbine and alternator.

### DETAILED DESCRIPTION OF THE INVENTION AND PREFERRED EMBODIMENTS THEREOF

The present invention provides a turbine-powered vehicle. The vehicle of the invention has a battery installation as is known in the art that may be charged by an alternator as known in the art. Typically, battery-powered vehicles known in the art have 6-12 batteries, and this is what is meant by “battery installation” herein. The battery installation and the battery connection to the car and the alternator are as is known in the art and are not illustrated herein. Although the vehicle of the invention herein is described as not having an engine, a radiator, a gas tank or an exhaust system, hybrid vehicles having these components in addition to the features of the invention are within the scope of the invention herein.

To initiate operation of the vehicle, the battery installation is used to start the vehicle as known in the art. In the embodiment shown and described herein, the turbine of the invention is mounted on top of the vehicle cab so that air coming over the top of the hood and windshield powers the turbine, which turns and runs an alternator which is linked to the turbine, which puts energy back into the battery installation. While this embodiment is mounted on top of the vehicle, the turbine may be placed under the vehicle hood, or under the vehicle frame, or elsewhere on the vehicle, with the main requirements being that there is space to fit the turbine, that the turbine is mounted to have an opening to the interior fins that faces forward so that air enters the turbine when the vehicle moves forward, and that there can be a working connection of the turbine to the alternator. The size of turbine used will depend upon what size is needed to generate the desired amount of electricity to boost the battery usage as desired. Similarly, different alternator output sizes and different pulley sizes may be used as known in the art. Even if this boost is not totally sufficient to continue the vehicle's movement indefinitely, the turbine of the invention together with the battery installation (and as needed, gasoline for hybrid vehicles), can power the vehicle.

Controllers as known in the art (not shown) are mounted on the turbine generating system of the invention to monitor electrical usage of the vehicle and to control the output of electricity from the alternator to the batteries, and to control the amount of electricity coming out of the battery installation to the electric motor propelling the vehicle.

In the embodiment herein, there is a belt between the turbine and the alternator, which is driven by a 1:1 ratio; however, it is contemplated that the invention may use a combination of pulleys changed out on the turbine or on the alternator, as known in the art to change this ratio. The alternator may alternatively be coupled directly to the turbine.

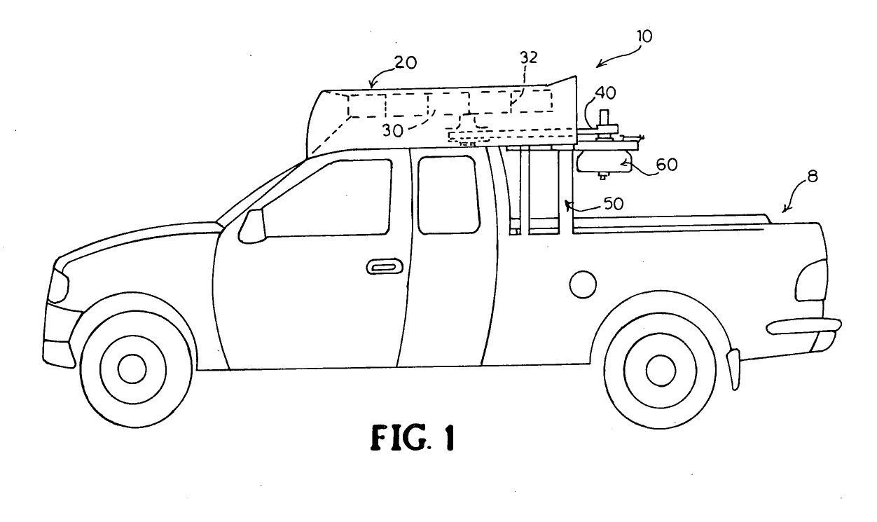

Referring in greater detail to the Figures, FIG. 1 shows a vehicle 8, shown in the figures as a pickup truck, with the invention 10 with a turbine 30 in a shroud 20 mounted thereon. As discussed in more detail below, the shroud has an opening 21 offset to one side of the shroud so that air flowing through the shroud 20 impacts one side of the turbine 30 that is mounted therein, causing the fins on that side of the turbine to rotate in a clockwise direction (as viewed from the top of the vehicle) if the opening 21 is on the right side of the vehicle as shown in the figures herein, which results in the correct direction of rotation of the attached belt and alternator as discussed below.

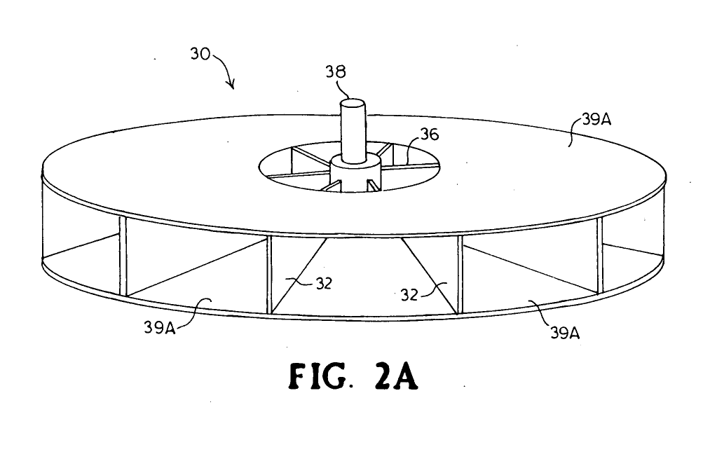

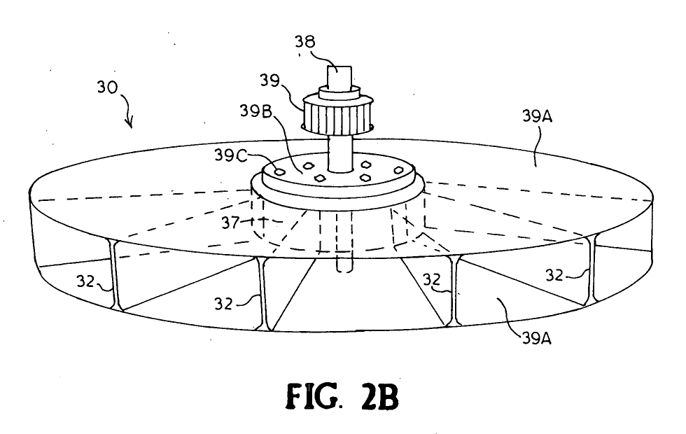

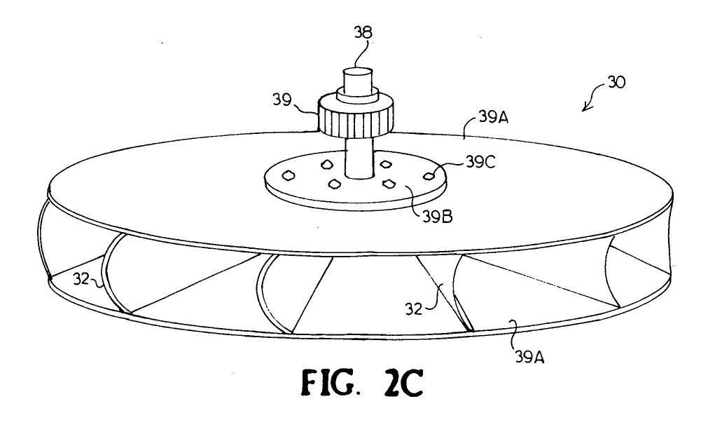

In the particular embodiment shown in the Figures (e.g., FIGS. 1-3D), turbine 30 is 44 inches in diameter by 4.25 inches wide, with 14 individual fins of which six fins 32 are shown. The fins 32 are 0.125 inch thick by 15 inches long, equally spaced 25.714 degrees around the entire turbine hub 37 and extending from the hub 37 to the outside edge of the turbine 30 (FIG. 2B). In the first embodiment, the fins 32 are rectangular and planar, as shown in FIGS. 2A and 2B, extending outward from hub 37.

In the second embodiment (FIG. 2C), the fins 32 are formed as linear half of an elongated cylinder with a C-shaped cross-section, each half-cylindrical fin 32 extending outward from hub 37, so that air hitting the interior curved surface of the half-cylinder when the vehicle moves forward is more accurately directed backward and inward toward the hub, pushing on the interior surface of the half-cylinder to cause the fin to move in a clockwise direction (as viewed from the top of the vehicle) when the C cross-sectional shape of the fin is oriented as shown in FIG. 2C.

The hub 37 is a cylinder machined 14 inches in diameter by 4.25 inches wide, with a 1.25 inch hole precision drilled through the center with spokes 36, instead of a solid interior, to reduce weight. Two aluminum plates 39a are cut precisely 44 inches in diameter with a 14-inch hole cut in the center of each. These components are welded together with one plate 39A above the fins 32 and one plate 39A below the fins 32 and the fins welded to both plates 39A (FIG. 2B) so that the turbine 30 and fins 32 can rotate without significant air passage around the fins 32, as known in the art and balanced to 6,000 RPM (FIGS. 2A and 2B).

Bolted to the center of the turbine 30 is a machined steel spindle 38 (FIGS. 2A-2C), which is a one-piece steel shaft turned to a larger 2-inch diameter for 7 inches on one end, reduced to a 1.25 inch diameter for 12 inches on the other end. Flat steel plate 39b is 0.75 inches thick machined flat, with a precision 1.25 inch hole drilled in the center. Plate 39B is slipped over the thinner end of spindle 38 and pushed up tight to the thicker end of spindle 38, and the assembly is balanced. The spindle 38 is welded at the point of reduction from 2 inches to 1.25 inches to steel plate 39b. The plate is trimmed on a lathe to a 13 inch diameter, and the spindle 38 bolted to the turbine 30 with six (6) 0.375-inch diameter bolts 39c.

The belt pulley 39 is 5 inches in diameter and 2 inches wide, fixed to the 2-inch end of the spindle 38. The belt pulley 39 is adjustable up and down to align the belt.

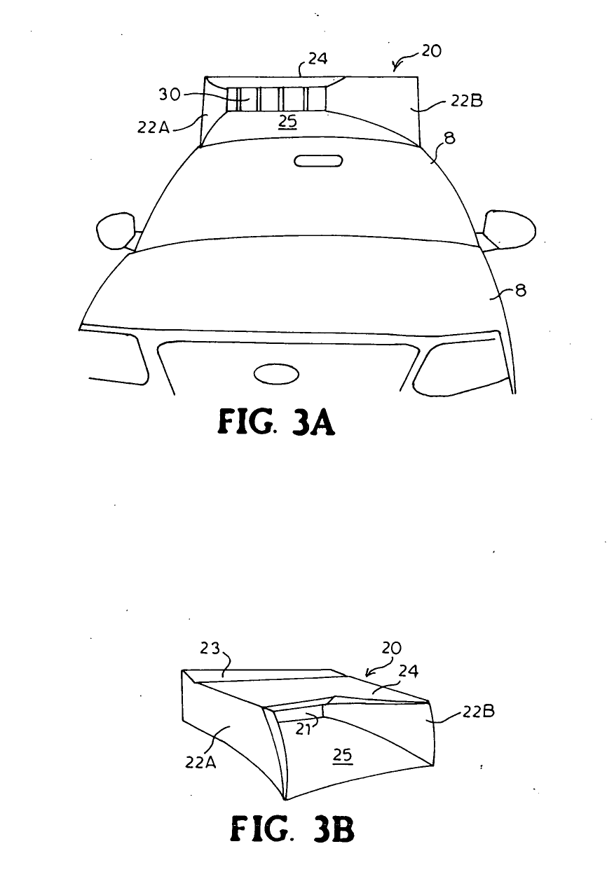

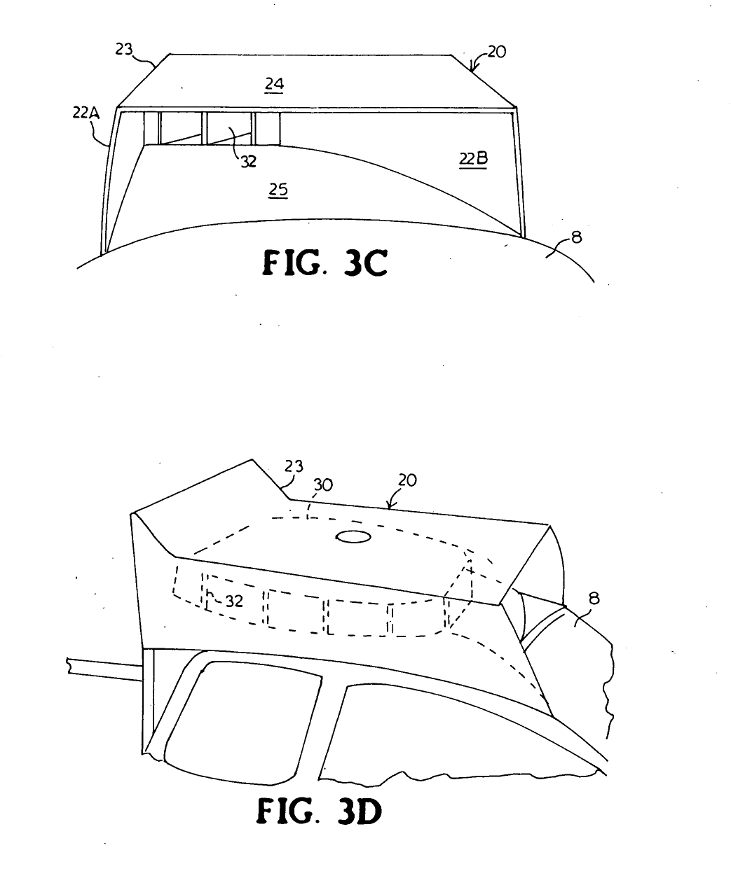

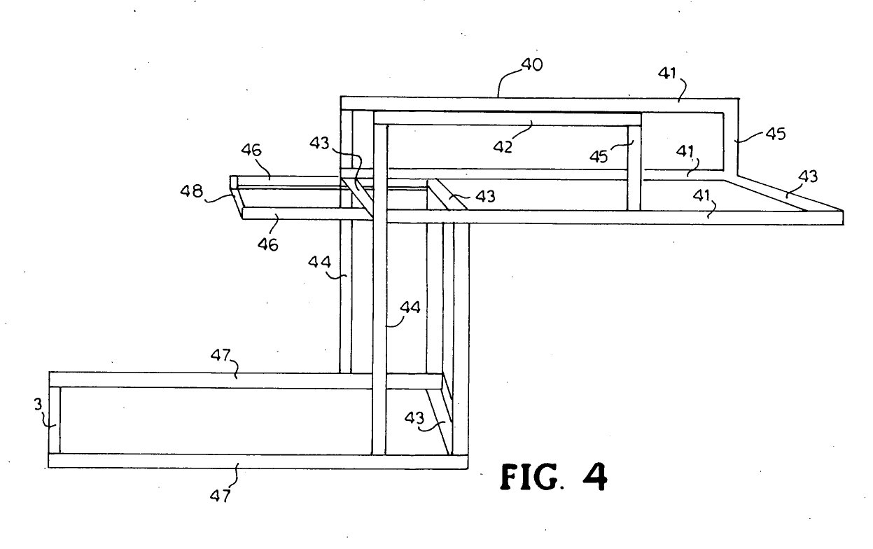

FIGS. 3A, 3C and 3D show the shroud 20 containing the turbine 30 mounted on a truck and FIG. 3b shows the shroud 20 itself. Shroud 20 is a fiberglass inlet shroud, which in this embodiments is 72 inches long×47 inches wide and 14.5 inches high. The shroud has an inlet 22. There are two sides 22A and 22B of the shroud, one of which 22A goes directly rearward at the right side of the vehicle to a rear opening 21 in the shroud 20 and one of which 22B angles across from the left side of the vehicle toward the opening 21 that is at the right side of the vehicle (in the embodiment shown in the figures).

There is an 8-inch wide×2.5-inch high ramp 23 on the trailing edge of the top 24 of the shroud that slopes all the way across the trailing edge to create a vacuum to assist in pulling to exhaust air through. The bottom 25 of the shroud is molded to fit closely to the top of the vehicle, and is attached to frame 40 by bolting in the embodiment pictured herein. For direct attachment within, under or on the vehicle as desired by the manufacturer, the shroud may be bolded or attached by other means known in the art to the appropriate portion of the vehicle. The turbine 30 fits close to an opening 21, which is about 19×4 inches. Opening 21 is offset to one side of the shroud 20 so that air does not hit the turbine evenly on the center, but impinges on the turbine 30 to one side of the turbine as shown in FIGS. 3A and 3C. Thus one side of the shroud extends rearward generally parallel to the air flow, and one side of the shroud extends in a curve rearward at an angle to the air flow to direct the air to the opening on one side of the back of the shroud 20 so that the air is directed to fins at one side of the turbine 30 to cause the turbine to turn as air impacts the exposed fins. At the inlet of the shroud 20, all surfaces are sloped to create a ram air effect, so that air going into the cowling must go through the turbine 30 under great pressure.

The shroud 20 is bolted to a mounting structure 40 shown in FIG. 4, preferably constructed of steel or aluminum 2×2×0.25 inch angle pieces welded together that holds the turbine 30, the shroud 20, the belt 40 and the alternator 80 in their respective places so they can be mounted on the vehicle for testing an evaluation. In the embodiment constructed for the top of the truck cap as shown herein, the length of the pieces of angle steel or aluminum used for the preferred mounting structures 40 (number of pieces of each length is in parentheses) is: angle 41 is 72 inches long (3), angle 42 is 57 inches long, angle pieces 43 are 46 inches long (5), angle pieces 44 are 51 inches long (2), angle pieces 45 are 14 inches long (2), angle pieces 46 are 33.5 inches long (2), angle pieces 47 are 72 inches long (2); and angle piece 48 is 17 inches long (1). The angle pieces are welded together as known in the art to provide support for the turbine 30 and shroud 20 of the invention herein. Other support means as known in the art may be used to hold the invention in the desired position on the vehicle without departing from the scope of the invention herein, and of course, when the invention is mounted within or under the vehicle support brackets and structures and attachment means to the vehicle can be made as dictated by the particular mounting arrangement and location, vehicle and size of turbine.

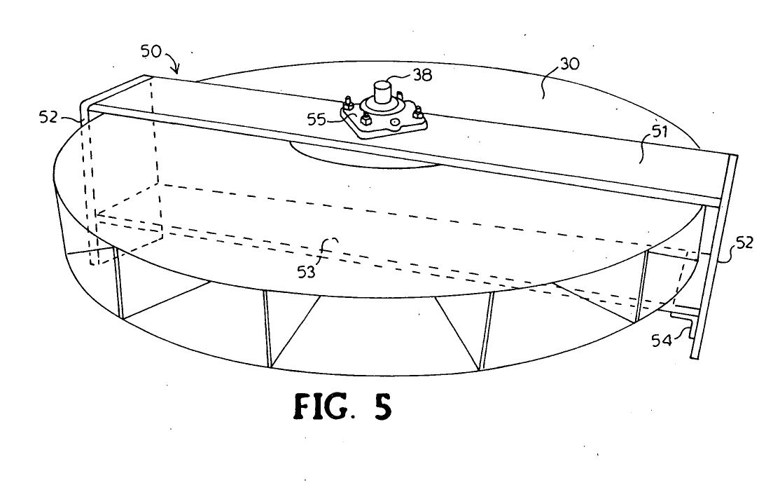

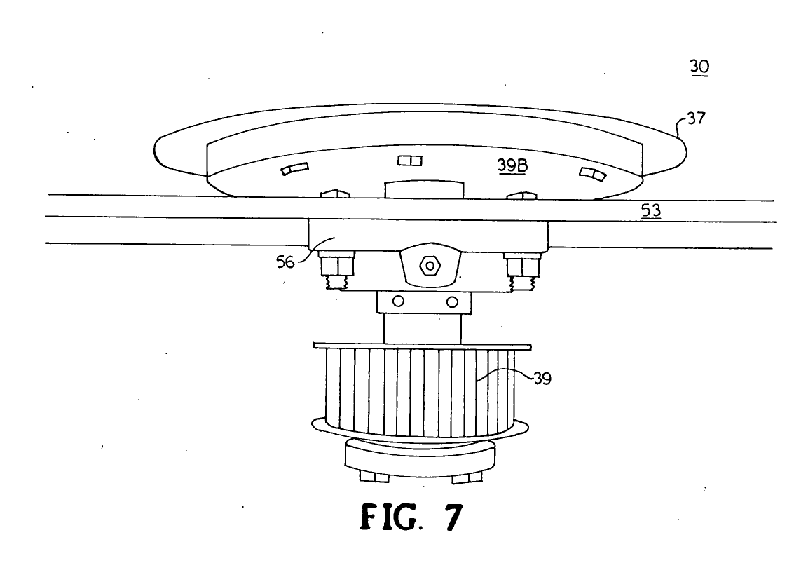

Turbine support bracket 50 is made of steel or aluminum, welded (FIG. 5) and is mounted under the fiberglass shroud 20 and bolted to frame 40. Bracket 50 aligns bearing 55 and bearing 56 (FIGS. 5 and 7). Plate 51 across the top of the turbine 30 is 44.5 inches long×8 inches wide×0.5 inch thick. Plates 52 are welded on to each end of plate 51 and are 10 inches long×8 inches wide×0.5 inch thick. Bottom plate 53 beneath the turbine is 44.5 inches long×8 inches wide×0.5 inch thick (the same size as plate 51). Angle pieces (2) 54 are 2×2×0.25 inches and 8 inches long and are welded to plate 52 beneath and at the ends plate 53 to tie these plates together. Bearing 55 is a 1.125-inch bearing (e.g., a Dodge bearing) centered above plate 51, and bolted to plate 51 with four 0.5-inch bolts on the exact center of plate 51. On the underside of turbine support bracket 50 beneath the turbine 30, a 2-inch bearing 56 (e.g., a Dodge bearing) is bolted in the exact center of plate 53 with four (4) 0.5-inch bolts (FIG. 7). Plate 53 is 7 inches below the underside of plate 51. Angle pieces 54 are bolted using three ½ inch bolts to to each of plates 52 and 53.

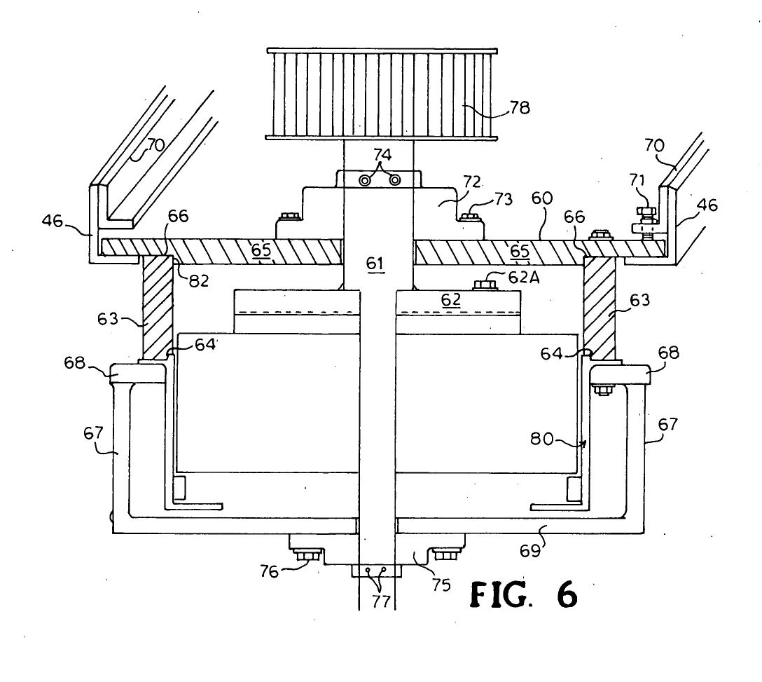

The alternator assembly has many parts to hold the alternator 80 securely in the position needed so that movement of the turbine fins 32 is transferred by belt 40 to the alternator, preferably by means of the pulleys discussed herein. The alternator 80 used in the embodiment of the invention depicted herein is a 34 KW alternator (FIG. 6). For this embodiment of the invention, an alternator from Polar Power model #8340 (22520 Avalon Blvd, Carson, Calif. 90745) was modified to fit the DC needs of the invention. A spindle 61 is machined precisely to have a 17-inch long shaft, turned to a close tolerance of 2 inches for the first 6.75 inches (top of spindle 61), then turned down to 1 inch diameter. Circular plate 62 is turned to an 8.375 inch diameter with a 1-inch hole drilled in the center. This plate 62 is slipped over the 1-inch diameter end of the spindle 61, and brought up tight to the 2-inch diameter portion of the spindle 61, and welded all around the 2-inch shaft, and then bolted to the armature of the alternator with four 0.5-inch bolts 62A.

Support pipe 63 is machined from a steel pipe to an 11.937 inch wide diameter and 3.075 inches long, with an outside diameter of 13.75 inch, and surrounds the spindle 61. A notch 64 on support pipe 63 is machined all the way around to 12.3125×0.125 deep to fit around the existing ring ridge on the alternator field 80.

Flat square steel plate 65 is 0.75 inch thick and 16.5 inches×16.5 inches. A flat area 66 is machined to match the inside of support pipe 63, which is machined to 11.937 inches. A drop-down edge 82 is formed by machining 0.25 off inch the steel plate so that steel plate 65 sits within support pipe 63 as shown in FIG. 6. This aligns the plate 65 to support pipe 63, so that a perfect alignment hole can be drilled in the middle of plate 65. Pulley 78 is attached to the 2-inch shaft 61. Bearing support bracket 67 aligns the bottom bearing 75 to the top bearing 72.

Bottom plate 69 is a rectangular piece of 0.5 inch thick steel×15.15 inch long×3.375 inch wide and is machined to have a central hole for placement of spindle 61, and is welded to support brackets 67, which are two flat rectangular plates (FIG. 6). Top plates 68 are flat plates 4 inches long welded to the top of support brackets 67, one on each side of alternator 80, and machined (not shown) to curve to closely fit the top of the alternator 80. Support brackets 67 are bolted to the alternator as shown.

The alternator 80 hangs on two angle pieces 46 (FIGS. 4 and 6) with plate 65 at the top of the alternator 80 resting on angles 46. Hold-down angle pieces 70 are 1.5×1.5×22 inches long×0.375 inch thick are welded to angle pieces 46 and are bolted to alternator 80. Bolts 71 (0.375 inch) with lock nuts secure angle pieces 70 to plate 65.

A two-inch bearing 72 is bolted to steel plate 65 with four (4) 0.5-inch bolts 73. Set screws 74 (0.25 inch) hold the bearing 72 to spindle 61.

A one-inch bearing 75 is bolted on to plate 69 with four (4) 0.5-inch bolts 76 at the bottom of the alternator 80. Two set screws 77 (0.187 inch) hold bearing 75 to spindle 61.

FIG. 7 shows the underside of turbine 30 with a two-inch bearing 56 mounted to plate 53 (also shown in FIG. 5). It is important that bearing 55 above the turbine 30 and bearing 56 below the turbine 30 are perfectly aligned. Belt pulley 39 is shown attached to spindle 38 which extends to turbine hub 37.

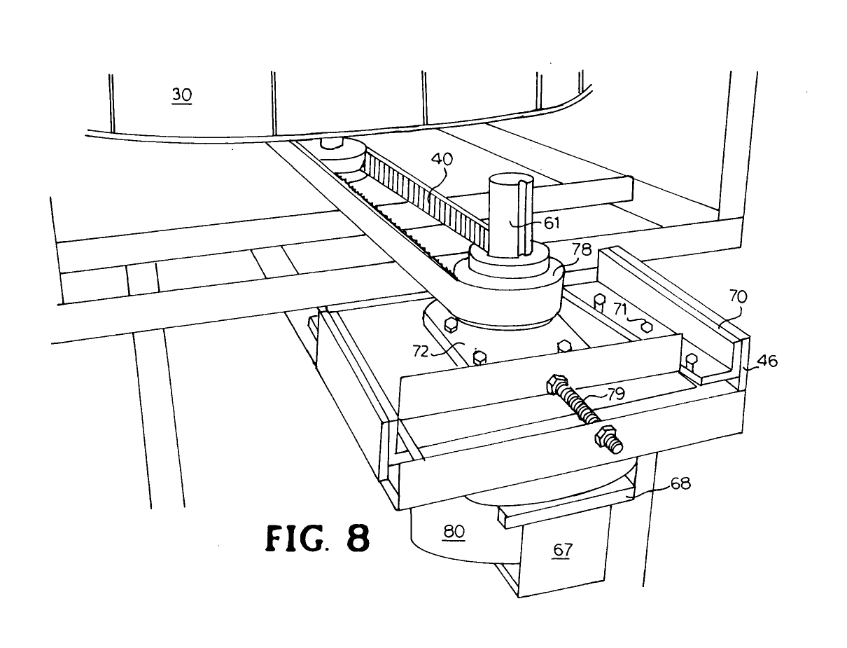

FIG. 8 shows belt 40 around belt pulley 78, bearing 72, hold-down angle pieces 46, angle pieces 70 held down to the alternator 80 with bolts 71, bearing support brackets 67 and the 0.5 inch bolt belt adjustment 79.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A vehicle having a battery installation, the vehicle further comprising:
a) a circular turbine mounted on the vehicle and having an interior with a plurality of fins radiating outward from a central hub;
b) a shroud surrounding the turbine and mounted on the vehicle to direct air on to fins at one side of the turbine, causing rotation of the fins about the central hub;
c) a turbine pulley on one side of the turbine that rotates when the fins rotate about the central hub;
d) an alternator connected to the vehicle battery installation, and having an alternator pulley;
e) a belt connecting the turbine pulley and the alternator pulley, wherein rotation of the turbine caused by hitting selected fins of the turbine with air upon forward movement of the vehicle causes the pulley turbine to rotate, which causes the belt to move, which causes the alternator pulley to rotate, which turns and runs the alternator and puts electricity into the battery installation.

2. The vehicle of claim 1, wherein the shroud is mounted on top of the vehicle.

3. The vehicle of claim 1, wherein the shroud has an inlet that slopes at an angle in to a rear opening in the shroud.

4. The vehicle of claim 1, wherein there are 14 fins.

5. The vehicle of claim 1, wherein the fins are in the form of a linear half on an elongated cylinder.

6. A method of powering a vehicle having a battery installation, comprising:
a) providing a vehicle according to claim 1;
b) starting the vehicle using the battery installation;
c) moving the vehicle forward with battery power to cause air hitting selected fins of the turbine to rotate the turbine, move the belt, run the alternator and put electricity into the battery installation.
